(19) United States
(12) Patent Application Publication
(10) Pub. No.: US 2006/0206561 A1
(43) Pub. Date: Sep. 14, 2006

(54) Personal multimedia on-line broadcasting system and method thereof

(75) Inventors: Chien Hua Chen, Taipei County (TW); Yu Feng Chueh, Taipei County (TW)

Correspondence Address: BACON & THOMAS, PLLC, 625 SLATERS LANE, FOURTH FLOOR, ALEXANDRIA, VA, 22314, US

(73) Assignee: TUL CORPORATION, Taipei County (TW)

(21) Appl. No.: 11/345,309

(22) Filed: Feb. 2, 2006

(30) Foreign Application Priority Data
Mar. 9, 2005 (TW) 94107152

(51) Int. Cl. G06F 15/16

(52) U.S. Cl. 709/203

(57) ABSTRACT

A personal multimedia on-line broadcasting system is provided, comprising: a network broadcasting server including a plurality of media sources, a network interface card, and a network broadcasting server module; and a client device including a network interface card, a video and audio output interface, and a client player module. The operation of the network broadcasting server module is controlled by a software application program to execute the following procedures: receiving a request from a client device, determining a broadcasting bandwidth, processing the streaming data of a video and audio signal, and broadcasting the streaming data to the client device according to the broadcasting bandwidth. The operation of the client player module is also controlled by a software application program to execute the following procedures: providing a human-machine interface for inputting server IP addresses, sending the request to the network broadcasting server, receiving the streaming data in order to output the video and audio signal to the video and audio output interface.

### BACKGROUND OF THE INVENTION

1. Field of the Invention

The present invention relates to a multimedia on-line broadcasting system and method thereof, and more particularly to a personal multimedia on-line broadcasting system and method thereof for integrating video and audio media sources of personal media platform to provide multimedia on-line broadcasting.

2. Description of the Related Art

As the application range of personal computers becomes wider, the peripheral apparatuses installed in personal computers have made personal computers be promoted to personal multimedia processing platform. In addition to Microsoft® Word processing platforms, other basic peripheral apparatuses such as network card, DVD player, web cam, etc. provide video and audio media processing platforms.

Due to the flexible open structure of a personal computer, referring to software and hardware resources of a personal computer shown in FIG. 1, a user can buy any media expansive card at any time to promote the multimedia processing capability of his personal computer. For example, installing a DVD player and an audio card in a personal computer will make the personal computer become a home video and audio player system; installing a TV card in a personal computer will provide the ability for the personal computer to receive TV signal and make the personal computer become a home TV; installing an extracting card in a personal computer will provide the ability for the personal computer to receive video and audio data and make the personal computer become a video and audio processing platform; or plugging a digital video camera or digital still camera with a USB interface into the USB port of a personal computer, then the personal computer can detect any new hardware device and get in a new video and audio media source at any time. Thus, personal multimedia processing platforms at present generally include a plurality video and audio media sources and provide the ability for a user to process multimedia information on a personal computer.

However, the operation of these DVD player, TV card, extracting card, and video and audio media source from an additional digital video camera or digital still camera is limited to the personal computer in which they are installed, and the presentation of the video and audio processing result is also limited to the video and audio output interface of the personal computer. Additionally and generally, a user directly operates a personal computer and respectively activates the DVD player, TV card, extracting card, and additional digital video camera or digital still camera without a media integration platform for selecting the media to be played.

However, when the user leaves home or his personal computer is not at hand, he can not remotely control these video and audio sources installed in his personal computer, nor able to control the these video and audio output result of these video and audio sources to broadcast them to far-end. As networking environment gets popular, even overseas, a user also can use network resources in a net café at any time, or use a handset, PDA, notebook computer, etc. to connect the Internet via wireless communication. A network structure of a video streaming server platform according to prior art is shown in FIG. 2. A personal computer may connect a server platform via the Internet to execute video and audio files, such as *.WMV, designated by specific IP addresses, thereby allowing the personal computer to view video and audio resources on line.

For allowing a far-end user to enjoy multimedia resources in a home personal media platform, the present invention provides a multimedia on-line broadcasting method, which can integrating various video and audio media sources by installing a network broadcasting server software in a personal computer or personal media platform, and allows a user to easily operate these video and audio media sources by connecting the personal computer or personal media platform at home via the Internet and broadcast the video and audio output results of these video and audio media sources to the user's terminal apparatuses such as a computer at a net café, a handset, a PDA, a notebook computer, an electrical communicative appliance, etc., wherein the electrical communicative appliance is a general electrical appliance which can be connected via a home local area network and has the ability to connect the network broadcasting server 10, allowing the electrical communicative appliance to share the multimedia resource of the network broadcasting server 10, and allowing the multimedia source of the personal media platform to be utilized more efficiently.

### SUMMARY OF THE INVENTION

It is one object of the present invention to provide a network broadcasting server software installed in a personal media platform to integrate video and audio media sources of the personal media platform and broadcast personal multimedia data via the Internet on line.

It is one object of the present invention to provide a multimedia on-line broadcasting method which can use a network broadcasting server software in connection with an video and audio media source of a TV card or DVD player to enhance a personal media platform to a personal multimedia on-line broadcasting system which can make on-line broadcasting via the Internet.

The present invention provides a personal multimedia on-line broadcasting system, comprising a network broadcasting server including a plurality of media sources for receiving video and audio signals, a network interface card having a server IP address and connecting the Internet, and a network broadcasting server module; and a client device including a network interface card having a source IP address and connecting the Internet, a video and audio output interface, and a client player module. The operation of the network broadcasting server module is controlled by a software application program to execute the following procedures: receiving a request from the client device, determining a broadcasting bandwidth, processing the streaming data of a video and audio signal, and broadcasting the streaming data to the client device according to the broadcasting bandwidth. The operation of the client player module is also controlled by a software application program to execute the following procedures: providing a human-machine interface for inputting server IP addresses, sending the request to the network broadcasting server, receiving the streaming data in order to output the video and audio signal to the video and audio output interface.

The personal multimedia on-line broadcasting system and method thereof performed according to the present invention can promote a personal media platform to a personal multimedia on-line broadcasting system by installing a network broadcasting server software in a personal computer such that a user can remotely connect his home personal computer via the Internet anytime and anywhere to make an on-line selection and operation of different media sources, such as a TV card and a DVD player. Additionally, the user can integrate various video and audio sources by the network broadcasting server software under the control of the resources of existing personal media platforms and broadcast video and audio output results. Thus, a user can easily obtain multimedia resources of a personal computer from far-end.

### BRIEF DESCRIPTION OF THE DRAWINGS

FIG. 1 is a block diagram for software and hardware of a personal computer according to prior art.

FIG. 2 is a network structure of a video streaming server platform according to prior art.

FIG. 3 is a structure of a personal multimedia on-line broadcasting system according to the invention.

FIG. 4 is a flowchart executed by the network broadcasting server application program of the invention.

FIG. 5 is a flowchart executed by the client player application program of the invention.

FIG. 6 is an embodiment of the invention using a TV card as the media source, illustrating a flowchart for transmission of video and audio media data between a network broadcasting server and a client device.

FIG. 7 is a flowchart of a method used by the inventive system to detect the network bandwidth.

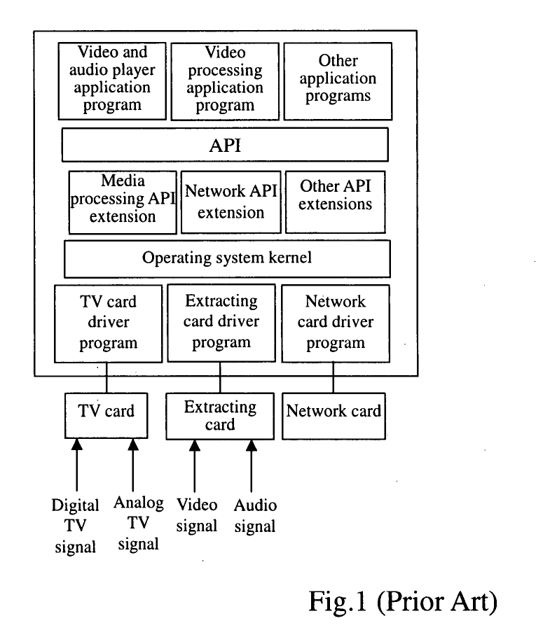

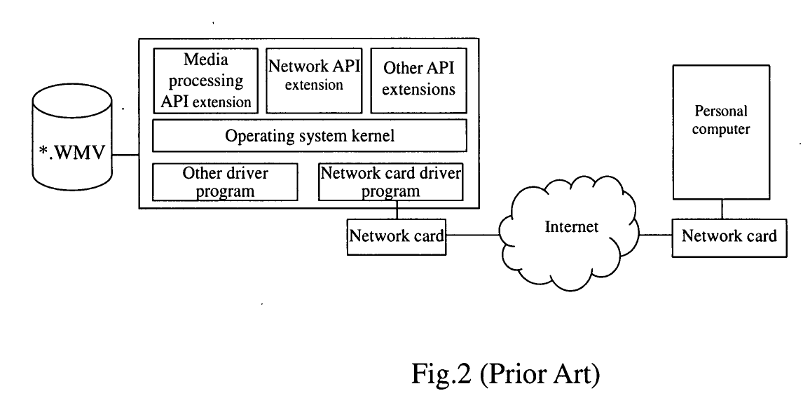

### DETAILED DESCRIPTION OF THE PREFERRED EMBODIMENTS

While the invention will be full descripted referring to accompanying drawings containing preferred embodiments of the invention, prior to the descriptuon, however, it will be recognized to those skilled in the art that changes and modifications may be made and the effects of the invention can also be obtained. Thus, it will be understood to those skilled in the art that the following descriptions are general disclosures and not intended to limit this invention.

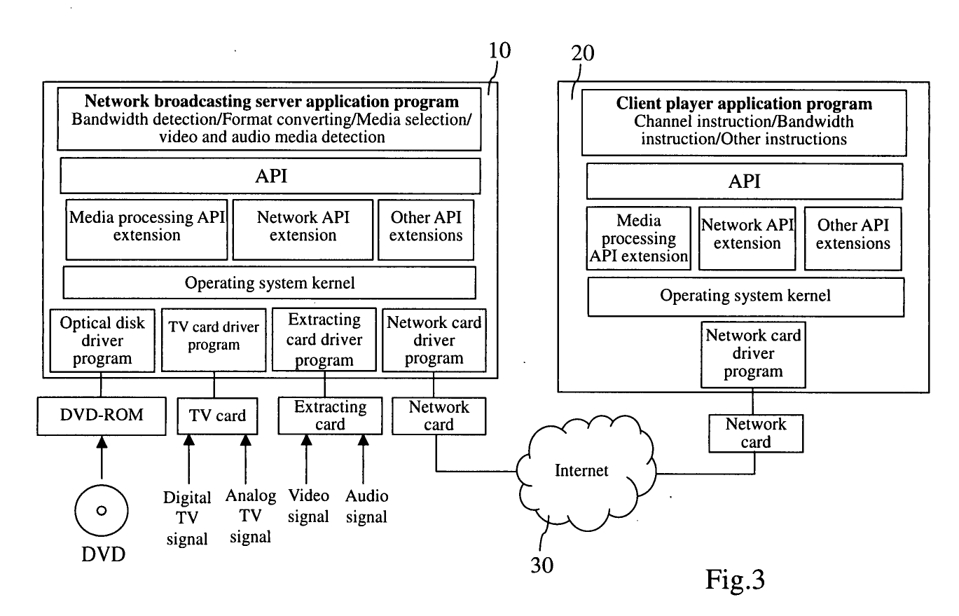

Referring to FIG. 3, a structure of a personal multimedia on-line broadcasting system according to the invention is shown. The personal multimedia on-line broadcasting system according to the invention contains a network broadcasting server 10 and at least one client device. According to a preferred embodiment of the invention, the network broadcasting server 10 is implemented by a user's home personal computer or personal media platform, and the client device is a device used by the user to connect the network broadcasting server 10 via the Internet at far-end. The client device may be implemented by existing network resources, such as a network computer at a net café or library, or a handset, a PDA, a notebook computer, an electrical communicative appliance having the Internet connection ability, wherein the electrical communicative appliance is a general electrical appliance which can be connected via a home local area network and has the ability to connect the network broadcasting server 10, allowing the electrical communicative appliance to share the multimedia resource of the network broadcasting server 10. As the embodiment shown in FIG. 3, the client device is implemented by a computer system provided with a network card, however, it may also be implemented by a device like a handset, a PDA, a notebook computer, etc. having wireless network resources or an electrical communicative appliance to use multimedia resources in a home personal computer or personal media platform.

In the preferred embodiment of the invention, the network broadcasting server 10 is implemented by a personal computer or personal media platform with a network broadcasting server application program installed therein. The personal computer or personal media platform includes a plurality of video and audio media sources and a network card. The network card causes the personal computer or personal media platform having a server IP address in the Internet. These video and audio media sources may include a DVD player, a TV card, an extracting card, and a plug-and-play digital video camera or a digital still camera, and the operating system software installed in the personal computer or personal media platform may use respective driver programs to control these video and audio media sources or obtain video and audio signals.

A network broadcasting server application program may integrate all video and audio sources of the network broadcasting server 10, and broadcast the streaming data of these video and audio signals to a client device in response to requests sent via a network from the client device. The network broadcasting server application program, which is installed in the environment of an operating system software, may execute the following procedures: video and audio media source detection, network bandwidth detection, media selection, video and audio stream transmission, wherein the network bandwidth detection procedure may detect the upload bandwidth of the network broadcasting server 10 or the download bandwidth of the client device in order to determine a broadcasting bandwidth.

As the embodiment shown in FIG. 3, a client player application program is installed in the client device. The client player application program may have different versions depending on the operating system software of different client devices. The client player application program may execute the following procedures: providing a human-machine interface, inputting server IP addresses, sending a bandwidth instruction request, sending a channel instruction request, sending a media selection request, receiving the streaming data in order to output the video and audio signal. The request sent from the client device may contain an IP address message of the client device, allowing the network broadcasting server application program may identify the client device's source IP address upon receiving the request.

In the business application of the invention, the client player application program is provided as a network resource which can be downloaded, allowing an user to be able to easily obtain the client player application program to be installed in the client device. And the install the network broadcasting server application program is provided to the user to be installed in his home personal computer or personal media platform to work with a video and audio media device like a TV card. Thus, the embodiment of the invention may be applied to a user's existing personal media platform, and may use a far-end network environment or a communicative device to easily install a client player application program, thus multimedia resources of a home personal computer or personal media platform are obtained.

For a manufacturer which provides video and audio media interface devices, the video and audio media device like a TV card can be sold together with a network broadcasting server application program, and can be installed in a user's home personal computer or personal media platform, thereby promoting the home personal computer or personal media platform to a personal multimedia on-line broadcasting system. It is helpful to increase the sales volume of the video and audio media device like a TV card.

The procedures executed by the inventive network broadcasting server program and the client player application program are further described below.

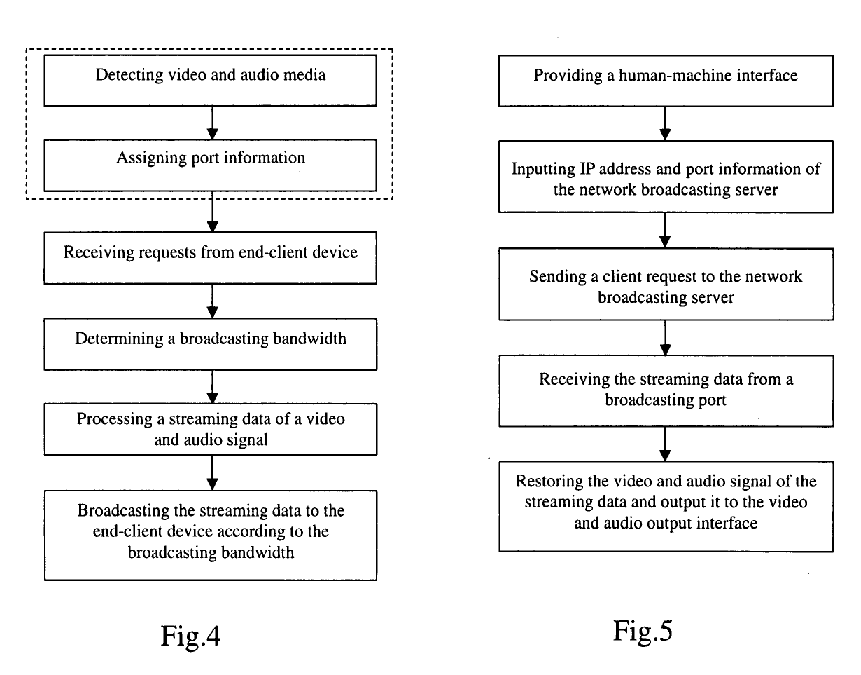

Referring to FIG. 4, a flowchart executed by the network broadcasting server application program of the invention is shown. In the preferred embodiment of the invention, the network broadcasting server application program will execute the following procedures in the network broadcasting server 10:

Detecting Video and Audio Media

During the process for installing a network broadcasting server application program in the network broadcasting server 10, the network broadcasting server application program not only sets the environment for software execution in the operating system, but also will detect the video and audio media sources, such as a DVD player, a TV card, an extracting card . . . etc., of the network broadcasting server 10, to obtain multimedia resource information of a personal computer or personal media platform. When a plug-and-play video and audio media apparatus is detected by the operating system, the network broadcasting server application program will also add a video and audio media source.

Assigning Port Information

During the process for installing a network broadcasting server application program in the network broadcasting server 10, the network broadcasting server application program will assign a broadcasting port and a socket port in the server IP address. The broadcasting port is used to transmitted the streaming data of the video and audio signal to the client device, and the socket port is used as an information (e.g. instruction requests or transmission port information) exchange channel between the network broadcasting server application program and the client player application program.

Receiving Requests from Client Device

The network broadcasting server application program will receive a request sent via the Internet from the client device and execute a corresponding procedure in response to the request. When the client device sends a bandwidth instruction request, the network broadcasting server application program will transmit the streaming data according to the transfer rate designated by the bandwidth instruction; when the client device sends a media selection request, the network broadcasting server application program will obtain video and audio signals from a designated video and audio media source according to the request to transmit to the client device; when the client device selects a TV channel media and sends a media instruction request, the network broadcasting server application program will interrupt the original video and audio streaming data and retransmit a video and audio streaming data from a designated channel according to the request.

In a further embodiment of the invention, in addition to inputting an account number and a password to ascertain the identity of the user during a connection request of the client device, for confirming the validity of the request transmitted from the client device, the network broadcasting server application program will further authenticate the request transmitted from the client device by an electrical transaction certificate operation to guarantee the user's identity on line.

Determining a Broadcasting Bandwidth

The network broadcasting server program will first determine a broadcasting bandwidth before it responds to the video and audio broadcasting request transmitted from the client device, this influences the quality of the video and audio media received by the client device. In a different embodiment of the invention, the network broadcasting server program may initially use a predetermined bandwidth as the broadcasting bandwidth, e.g. 512 Kb/s. Alternatively, the client device can issue a bandwidth instruction request for changing the broadcasting bandwidth in order to reflect the quality of the video and audio media, then the network broadcasting server application program will interrupt the original video and audio media broadcasting in response to the request sent from the client device and use the designated bandwidth as the broadcasting bandwidth according to the bandwidth instruction request.

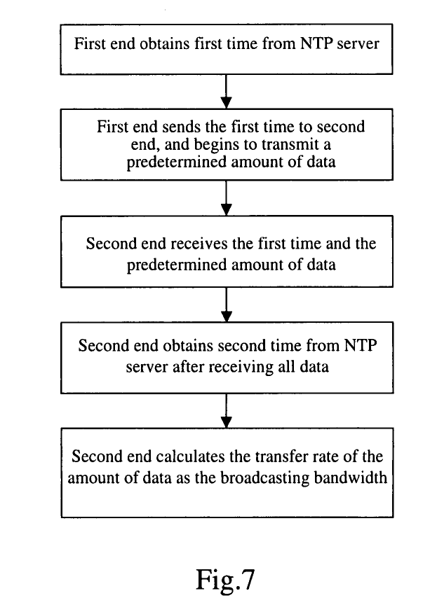

For optimizing the video and audio media broadcasting status, according to the system and method of the invention, the network broadcasting server application program may automatically detect the network bandwidth status to determine a broadcasting bandwidth, that is it will detect the upload bandwidth of the network broadcasting server 10 or the download bandwidth of the client device in order to determine a broadcasting bandwidth. The method for detecting the network bandwidth used by the inventive system is shown in the flowchart of FIG. 7 and will be further described as follows.

Processing the Streaming Data of a Video and Audio Signal

When the network broadcasting server application program accepts the video and audio request sent from the client device, the network broadcasting server application program will begin to receive the video and audio signal with using the media source designated by the client device or using a predetermined TV card as the media source, and then convert the video and audio data into a streaming data. which can be communicated in a network. In an embodiment, at the start of receiving the video and audio signal for processing the video and audio media data, the network broadcasting server application program will temporarily store the video and audio media data in a media buffer, and then convert the data into a streaming data of WMV format. Therefore, the video and audio media data from a media source will be broadcasting to the Internet after a period of delay.

Broadcasting the Streaming Data to the Client Device According to the Broadcasting Bandwidth

When the network broadcasting server application program begins to process the streaming data of the video and audio signal, it will broadcast the streaming data from the broadcasting port to the client device according to the broadcasting bandwidth determined by abovementioned procedures.

Referring to FIG. 5, a flowchart executed by the client player application program of the invention is shown. In a preferred embodiment of the invention, the client player application program will execute the following procedures in the client device:

Providing a Human-Machine Interface

The client player application program will provide a human-machine interface in a client device after being installed in the client device. The human-machine interface includes video and audio playing operation, instruction inputting operation, and instruction menu operation, etc. In a preferred embodiment of the invention, after the client device establishes a connection with the network broadcasting server 10, the human-machine interface may provide multimedia resources for the network broadcasting server 10. These multimedia resources include any video and audio media source e.g. a DVD player, a TV card, an extracting card, or a plug-and-play digital video camera or a digital still camera, etc., installed in the network broadcasting server 10. A user can operate the instruction menu for requesting one of these video and audio media sources of the network broadcasting server 10 to provide video and audio broadcasting service.

Inputting IP Address and Port Information of Network Broadcasting Server 10

For establishing the connection between the client device and the network broadcasting server 10, the human-machine interface will allow the user to input the server IP address and the port information of the network broadcasting server 10. Wherein the port information includes the broadcasting port of the server IP address for receiving the streaming data from the network broadcasting server 10. After establishing the connection, the client device can transmit a client request by a socket port.

In a further embodiment of the invention, in addition to inputting an account number and a password in response to the request of the network broadcasting server 10 to ascertain the identity of the user during the process of establishing the connection, for confirming the identity of the user of the client device, the client player application program will further authenticate the request transmitted from the client device by an electrical transaction certificate operation to guarantee the user's identity on line.

Sending a Client Request to Network Broadcasting Server 10

A user can use the human-machine provided by the client player application program to operate the instruction menu to issue a client request to the network broadcasting server 10. In a preferred embodiment of the invention, the client request may include: bandwidth assignment request, media selection request, bandwidth detection request, etc., or video and audio playing request and interrupt request for a DVD-ROM media, or channel switch request for a TV channel request.

Receiving the Streaming Data from Broadcasting Port

When the network broadcasting server application program confirms the validity of the request of the client request, the client player application program may receive the streaming data of the video and audio media via the broadcasting port.

Restoring a Video and Audio Signal of the Streaming Data and Outputting to the Video and Audio Output Interface

The client player application program will restore the received streaming data to video and audio signals, and output the signals to the video and audio output interface of a display and speakers, in order to provide the video and audio playing service for a user.

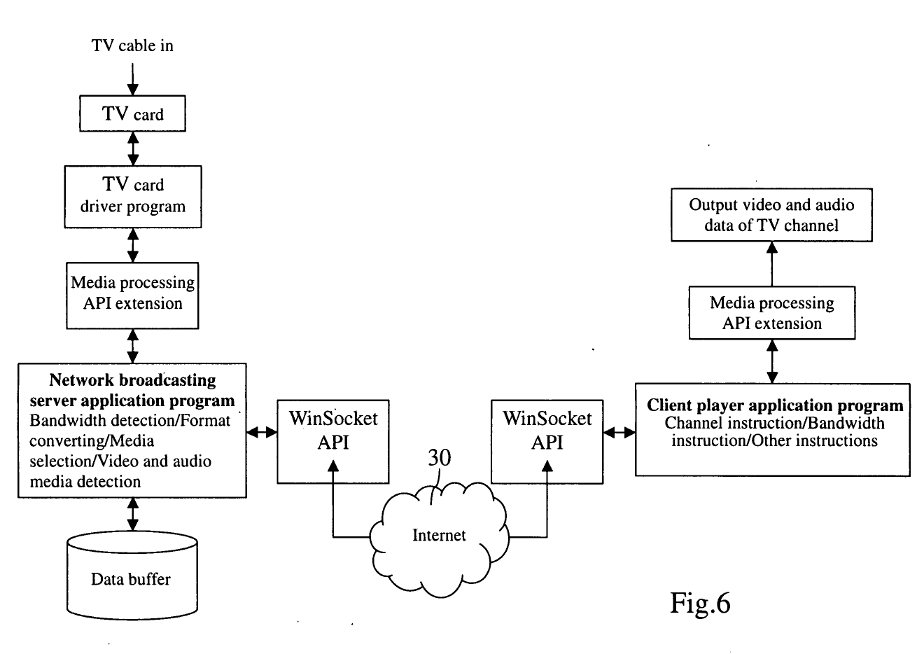

Referring to FIG. 6, an embodiment of the invention using a TV card as the media source for the network broadcasting server 10 is shown, illustrating a flowchart for transmission of video and audio media data between the network broadcasting server 10 and a client device. According to this embodiment of the invention, the network broadcasting server application program is installed in the network broadcasting server 10 to be executed in the platform provided by the operating system software of the network broadcasting server 10, and the client player application program is installed in the client device to be executed in the platform provided by the operating system software of the client device.

The network broadcasting server application program will call the WinSocket API to process the information transmitted from the client player application program, and in response to the client's requesting for video and audio broadcasting, the network broadcasting server application program will call the media processing API extension to control a TV card via a TV card driver program to obtain the video and audio signal of a TV channel transmitted from the TV cable. The network broadcasting server application program will temporarily store the media data of the video and audio signal in a data buffer, and then convert the media data into a streaming data of WMV format. The network broadcasting server application program will call the WinSocket API to process the streaming data and transmit to the client player application program.

The client player application program will call the WinSocket API to receive the streaming data and restore the video and audio signal of a TV channel, and then output the video and audio signal to the video and audio output interface via the media processing API extension.

Referring to FIG. 7, a flowchart of a method used by the inventive system to detect the network bandwidth is shown. The method used by the inventive system to detect the network bandwidth may be implemented in the network broadcasting server 10 for detecting the upload bandwidth of the client device or the download bandwidth of the network broadcasting server 10. Also, the method may be implemented in the client device for detecting the upload bandwidth of the client device or the network broadcasting server 10 or the download bandwidth of the client device.

The flowchart illustrated in FIG. 7 illustrates a method for detecting the network bandwidth by using the detection of the upload bandwidth of a first end and the download bandwidth of a second end as an example, which comprising the following procedures:
First end obtains a first time from a NTP server on a network;
First end sends the first time to second end, and begins to transmit a predetermined amount of data to second end;
Second end receives the first time and the predetermined amount of data transmitted from first end;
Second end obtains a second time from the NTP server on the network after second end has received all data transmitted from first end; and
Second end calculates the transfer rate of the amount of data as the broadcasting bandwidth between first end and second end.

Thus, in one embodiment of the invention, the network broadcasting server 10 is used as the first end and the client device is used as the second end. For determining the best broadcasting bandwidth, the network broadcasting server 10 will transmit based on the standard time of a NTP server a predetermined amount of data (or a predetermined length of data package) to the client device, and the client device will calculate based on the standard time of the NTP server the transfer rate of the received amount of data (or data package) in order to issue a request for designating the transfer rate as the broadcasting bandwidth.

Having described the preferred embodiments of this invention, it should be readily apparent to those skilled in the art that the invention can be altered and modified without departing from the scope and spirit of the accompanying claims, in addition, the present invention is not limited to these implementations of such embodiments exemplified in the specification.

What is claimed is:

1. A personal multimedia on-line broadcasting system, comprising:
a network broadcasting server including a plurality of media source devices for receiving a video and audio signal, a network interface card having a server IP address and connecting the Internet, and a network broadcasting program means for causing said network broadcasting server to receive a request having a source address, determine a broadcasting bandwidth, process the streaming data of said video and audio signal, and broadcast said streaming data to said source IP address according to said broadcasting bandwidth; and
a client device including a network interface card having said source IP address and connecting the Internet, a video and audio output interface, and a client player module, wherein said client player program means for causing said client device to input said server IP address, send said request to said server IP address, receive said streaming data in order to output said video and audio signal to said video and audio output interface.

2. The personal multimedia on-line broadcasting system as claimed in claim 1, wherein said media source devices comprise a TV card or an extracting card or a DVD player or a web cam or a plug-and-play digital video camera and a digital still camera.

3. The personal multimedia on-line broadcasting system as claimed in claim 1, wherein said network broadcasting server module is operated to detect the download bandwidth of said client device as said broadcasting bandwidth.

4. The personal multimedia on-line broadcasting system as claimed in claim 1, wherein said network broadcasting server module is operated to determine a broadcasting port for broadcasting said streaming data of said video and audio signal, and said client player module is operated to assign said broadcasting port of said server IP address for receiving said streaming data of said video and audio signal to the client device.

5. The personal multimedia on-line broadcasting system as claimed in claim 1, wherein an information exchange port is used for delivering information between said network broadcasting server module and said client player module.

6. A network broadcasting server for personal multimedia on-line broadcasting, comprising:
a media source device for receiving a video and audio signal;
a network interface card having a server IP address and connecting the Internet; and
a network broadcasting program means for causing said network broadcasting server to receive a request having a source IP address, detect a broadcasting bandwidth of said source IP address, process the streaming data of said video and audio signal, and broadcast said streaming data to said source IP address according to said broadcasting bandwidth.

7. The network broadcasting server as claimed in claim 6, wherein said media source device comprise a TV card or an extracting card or a DVD player or a web cam or a plug-and-play digital video camera and a digital still camera.

8. The network broadcasting server as claimed in claim 6, wherein said network broadcasting server module is operated to detect said media source device and assign a port information.

9. The network broadcasting server as claimed in claim 8, wherein said port information is a broadcasting port for broadcasting said streaming data of said video and audio signal.

10. The network broadcasting server as claimed in claim 8, wherein said port information is an information exchange port for delivering messages or receiving said request.

11. The network broadcasting server as claimed in claim 6, wherein said network broadcasting server module will detect the network bandwidth of said source IP address based on the standard time of a NTP server for delivering a predetermined amount of data to a client device having said source IP address, and said client device will calculate based on the standard time of said NTP server the transfer rate of the received amount of data as the network bandwidth.

12. A personalized media on-line broadcasting method implemented in a network broadcasting server platform, said network broadcasting server platform including a source media device and a network interface, said personalized media on-line broadcasting method comprising the steps of:
responding to a request having a source IP address, wherein said request is received via said network interface;
determining a broadcasting bandwidth;
processing a video and audio signal of said source media device for converting into a streaming data; and
broadcasting said streaming data to said source IP address based on said broadcasting bandwidth.

13. The personalized media on-line broadcasting method as claimed in claim 12, further comprising: detecting the download bandwidth of said source IP address as said broadcasting bandwidth.

14. The personalized media on-line broadcasting method as claimed in claim 12, further comprising: detecting the download bandwidth of said source IP address based on the standard time of a NTP server for delivering a predetermined amount of data to a client device having said source IP address, and said client device will calculate based on the standard time of said NTP server the transfer rate of the received amount of data and return to said network broadcasting server platform.

15. The personalized media on-line broadcasting method as claimed in claim 14, further comprising: using said returned transfer rate as said broadcasting bandwidth, in order to broadcast said streaming data to said source IP address.

16. The personalized media on-line broadcasting method as claimed in claim 12, further comprising: determining a broadcasting port for broadcasting said streaming data of said video and audio signal.

17. The personalized media on-line broadcasting method as claimed in claim 12, further comprising: determining an information exchange port for delivering messages or receiving said request.

18. A personalized media on-line broadcasting method, comprising:
selling a TV card, said TV card is used for installing in a personal computer connected to the internet;
providing a network broadcasting server software, said network broadcasting server software is used for installing in said personal computer, and said personal computer can execute said network broadcasting server software for implementing the following procedures:
responding to a request having a source IP address, wherein said request is received from the internet by said personal computer;
determining a broadcasting bandwidth;
processing a video and audio signal of said TV card for converting into a streaming data; and
broadcasting said streaming data to said source IP address based on said broadcasting bandwidth.

19. The personalized media on-line broadcasting method as claimed in claim 18, further comprising: detecting the download bandwidth of said source IP address as said broadcasting bandwidth.

20. The personalized media on-line broadcasting method as claimed in claim 18, further comprising: determining a broadcasting port for broadcasting said streaming data of said video and audio signal, and determining an information exchange port for delivering messages or receiving said request.
